(19) United States
(12) Patent Application Publication
(10) Pub. No.: US 2013/0332861 A1
(43) Pub. Date: Dec. 12, 2013

(54) INTERNET BASED PLATFORM FOR ACQUISITION, MANAGEMENT, INTEGRATION, COLLABORATION, AND DISSEMINATION OF INFORMATION

(71) Applicants: Frank Armstrong D'Agnese, Tucson, AZ (US); Julia Armstrong D'Agnese, Tucson, AZ (US)

(72) Inventors: Frank Armstrong D'Agnese, Tucson, AZ (US); Julia Armstrong D'Agnese, Tucson, AZ (US)

(21) Appl. No.: 13/997,579

(22) PCT Filed: Dec. 22, 2011
(86) PCT No.: PCT/US2011/066939

§ 371 Date: Aug. 26, 2013

Related U.S. Application Data
(60) Provisional application No. 61/460,031, filed on Dec. 23, 2010.

(51) Int. Cl. H04L 29/06

(52) U.S. Cl. CPC H04L 65/403
USPC 715/753

(57) ABSTRACT

A data collaboration system includes first and second users providing first and second quantities of content data, respectively. The first and second users provide the first and second quantity of content data, respectively, to a collaboration environment. A user collaboration module within the collaboration environment has a plurality of data tools usable by the first and second users who, in collaboration, use the plurality of data tools to create a third quantity of content data from the first and second quantities of content data. A data processing platform is in communication with the collaboration environment, wherein the third quantity of content data is uploaded to the data processing platform and integrated with existing content data, wherein additional users access the data processing platform through additional collaboration environments and control at least part of the integration of the third quantity of content data within the data processing platform.

### CROSS REFERENCE TO RELATED APPLICATION

This application claims benefit of U.S. Provisional Application Ser. No. 61/460,031 entitled, “Internet based platform for acquisition, management, integration and dissemination of earth, environmental and social science information” filed Dec. 23, 2010, the entire disclosure of which is incorporated herein by reference.

### FIELD OF THE DISCLOSURE

The present disclosure is generally related to Internet based data platforms and more particularly is related to Internet based platforms for acquisition, management, integration, collaboration, and dissemination information.

### BACKGROUND OF THE DISCLOSURE

Conventional web-based data management and analysis systems are commonly developed utilizing an open-source, software-development framework, and are designed predominantly to address the data needs and usage behavior of the scientific community. However, in recent times, society is demanding that certain issues of social concern be evaluated and addressed by an interdisciplinary class of qualified personnel. For example, environmental issues, such as earth science and environmental resource often required interdisciplinary investigators from the scientific, engineering, planning, and regulatory communities; not just scientists alone and not just regulatory bodies alone. Often these investigators are required to interact with a larger community of public stakeholders to gather data or disseminate it.

Technological innovations have assisted in making it easier for the larger public community to be part of these societal discussions. In particular, two critical technological innovations have occurred to assist participants engaged in these societal decision-making exercises. The first is the second-generation Internet, or Web 2.0, technologies found in web-based communities and hosted services (such as social-networking, wikis, web-logs, social bookmarking, podcasts, and RSS web feeds), which have become a commonplace means of facilitating communication between online groups. The second is with the transition of traditional two-dimensional geographic information systems into client-based and web-based, two-dimensional and three-dimensional visualization systems, such as Google Earth® and Google Maps®.

Often by necessity, when investigators are faced with providing analysis on a particular issue, they attempt to develop or utilize databases and models to assist. However, these databases and models are frequently derived from disparate data sets that are often large, complex, and vary dramatically in scale and quality. Data disparity results in models that provide inaccurate information, leaving open the possibility of action, whether at a consumer level or a regulatory level, which is based on faulty information. Investigators are unable to gather reliable information from reliable sources without recollecting the data from the beginning.

To overcome this problem, some investigators have meshed these databases with systems that already contain the data that the investigators need. For example, some systems tap into sources, such as on-line sources like the Web 2.0, to mine for data that is relevant to the particular issue they are studying. Although the investigators have been successful in part, there are many shortcomings of these conventional systems. For one, these conventional systems merely gather data for review. They do not filter out portions of the data that are incorrect or irrelevant. Secondly, these conventional systems tend to rely heavily on the information gathered without determining the accuracy of the data or performing any analysis on the data. For example, these conventional systems tend to incorporate the gathered data into the databases and models immediately, without subjecting the data to any sort of collaborative review.

Thus, a heretofore unaddressed need exists in the industry to address the aforementioned deficiencies and inadequacies.

### SUMMARY OF THE DISCLOSURE

Embodiments of the present disclosure provide a data collaboration system and associated methods thereof. Briefly described, in architecture, one embodiment of the system, among others, can be implemented as follows. The data collaboration system includes a first user providing a first quantity of content data and a second user providing a second quantity of content data. A collaboration environment is accessible to the first and second users, wherein the first and second users provide the first and second quantity of content data, respectively, to the collaboration environment. A user collaboration module is within the collaboration environment and has a plurality of data tools usable by the first and second users, wherein the first and second users, in collaboration, use at least a portion of the plurality of data tools to create a third quantity of content data from the first and second quantities of content data. A data processing platform is in communication with the collaboration environment, wherein the third quantity of content data is uploaded to the data processing platform and integrated with existing content data, wherein a plurality of additional users have access to the data processing platform through a plurality of additional collaboration environments, wherein the plurality of additional users control at least a portion of the integration of the third quantity of content data within the data processing platform.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of a data collaboration system, in accordance with a first exemplary embodiment of the present disclosure.

FIG. 2 is a schematic diagram of a data collaboration system, in accordance with a second exemplary embodiment of the present disclosure.

FIG. 3 is a chart illustrating technology groups related to user expectation, information needs, and data complexity of the system, in accordance with the second exemplary embodiment of the present disclosure.

FIG. 4 is a schematic illustration of a general-purpose computer, in accordance with a third exemplary embodiment of the present disclosure.

### DETAILED DESCRIPTION

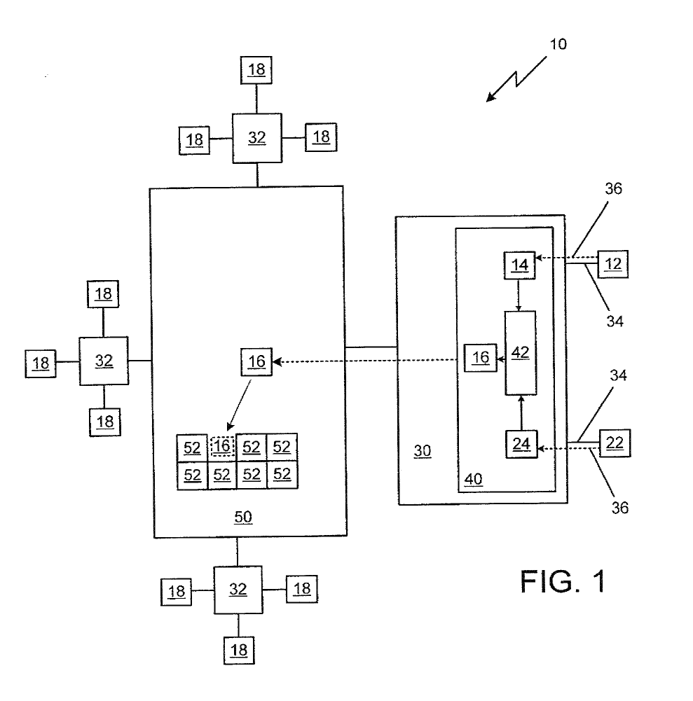

FIG. 1 is a schematic diagram of a data collaboration system 10, in accordance with a first exemplary embodiment of the present disclosure. The data collaboration system 10, hereinafter referred to as ‘system 10’ includes a first user 12 providing a first quantity of content data 14 and a second user 22 providing a second quantity of content data 24. A collaboration environment 30 is accessible to the first and second users 12, 22, wherein the first and second users 12, 22 provide the first and second quantity of content data 14, 24, respectively, to the collaboration environment 30. A user collaboration module 40 is within the collaboration environment 30 and has a plurality of data tools 42 usable by the first and second users 12, 22. The first and second users 12, 22, in collaboration, use at least a portion of the plurality of data tools 42 to create a third quantity of content data 16 from the first and second quantities of content data 14, 24. A data processing platform 50 is in communication with the collaboration environment 30, wherein the third quantity of content data 16 is uploaded to the data processing platform 50 and integrated with existing content data 52. A plurality of additional users 18 have access to the data processing platform 50 through a plurality of additional collaboration environments 32, wherein the plurality of additional users 18 control at least a portion of the integration of the third quantity of content 16 data within the data processing platform 50.

The system 10 of the present disclosure is directed to an electronic, network-based platform for the acquisition, management, integration, collaboration and dissemination of data and information between pluralities of user. As is discussed herein with reference to the various embodiments and examples, the architecture of the system 10 may facilitate geographically distributed communities and users the ability to access, analyze, collaborate and manage scientific and non-scientific data, information, and multimedia utilizing a variety of tools, namely social networking tools and collaboration tools. In particular, the system 10 provides web-based and client-based tools and services that may support on-line collaboration, community discussion, and broad public dissemination of earth science, environmental, engineering, economic, and social science, data and information in a wide-area distributed network. The system 10 may exploit familiar software tools using industry standard protocols, formats, and APIs to discover, process, fuse, and visualize both existing and developing environmental datasets using Google Earth® and Google Maps® and other mapping tools.

The system 10 may be integrated with world and geographic information systems, expert systems, content-management systems and social networking and collaboration media tools to help distributed communities and users collaborate, communicate, engage, inform, and educate their key audiences. The system 10, in turn, may provide previously unattainable access to new and historical expert-based information, channels for communication and collaboration of the information between multiple organizations, three-dimensional and four-dimensional mapping, visualization, and animation tools for analyzing the information, access to live data streams of the information from cameras, sensors, and monitoring stations, automatic classification systems of the information using multimedia content with semantic technology, and automatic mapping of locations associated with the information, as well as many other benefits.

The data and information entered in, exchanged through, or outputted from the system 10 may include any type and quantity of data. Preferably, the system 10 is suited to be used with data relating to environmental and social subjects, such as Earth sciences, the environment, engineering, social, political, and economic sciences, or any combination thereof. Other information may include but it not limited to, (1) natural hazards information (i.e. wildfires, storms, earthquakes, volcanic eruptions, tsunamis, flooding, landslides, etc) and natural resources information that may be useful to the insurance industry, energy industry, transportation industry, city planning, extractive industries (i.e. mining, forestry, oil/gas, etc.), and global/climate change mitigation/adaptation; (2) sustainable development information (i.e. land use planning, urban sustainability, building information models, facilities management, transportation routing); (3) emergency management information (i.e. homeland/global security, disaster preparedness, military tactical decision aids, counter-terrorism, security sensor/monitoring networks; and (4) education, outreach, and technology transfer information (i.e. online learning/education, weather broadcasting, museum exhibits, best practices). Of course, many other subjects including those not explicitly mentioned herein, may also be used with the system 10, all of which are considered within the scope of the present disclosure.

As described with reference to FIG. 1, the system 10 includes at least a first user 12 and a second user 22. However, any number of users may be included with the system 10, and commonly a large number of users, such as 10, 100, or 1,000 users or more is anticipated. The first user 12 may provide a first quantity of content data 14 and the second user 22 may provide a second quantity of content data 24. The first and second quantities of content data 14, 24, may include any type of data or information in any quantity, and may not be commensurate with one another. For example, the first quantity of content data 14 provided by the first user 12 may include a significant quantity of data relating global temperatures, such as temperatures at specific locations over time, a report on global warming, or some other large quantity of data, whereas the second quantity of content data 24 provided by the first user 22 may be a small amount of information, such as a single temperature at a single location at a single time, or basic knowledge on global warming. Any type of information or content data provided by any user is included within the scope of the present disclosure.

Often, the type of content data or information that is provided by the first and second users 12, 22 may be correlated to some characteristic of the user. For example, users may be classified or categorized into various groupings, such as general users, informed decision maker users, and subject-matter experts, or another category. For example, in relation to the topic of environmental water usage, the general user may be an average citizen, whereas the informed decision-maker is a water resource manager, and the expert is an earth or environmental scientist, such as a hydrogeologist. This may be based on characteristics like the user's experience, area of expertise, or length of expertise. A general user may provide less content data than a user who is an informed decision maker or a subject-matter expert.

It may also be the case where users are skilled or qualified in different subject areas, and provide content data in their respective subject areas, but collaborate within the system 10 within a mutual subject area. For example, the first user 12 may be an expert in the environmental protection of watershed areas, whereas the second user 22 may be an expert in land zoning and development regulations, where the first and second user 12, 22 may collaborate to provide content data concerning proposed regulations of commercial development proximate to watershed area.

It is also noted that either of the first or second users 12, 22, may include an electronic-based content data provider. This user may include a website, or computerized device with data, that is in communication with the collaboration environment 30. As is known in the art, the World-Wide Web (the Web), and the millions of websites within the Web, contains vast amounts of data relating to virtually any subject. Certain websites, such as online dictionaries, online encyclopedias, or other online data banks may be considered a user within the system 10. The data that is contained within these websites may be accessed by the system 10, or may be uploaded, transmitted, or otherwise provided to the system 10.

The first and second users 12, 22 have access to the collaboration environment 30 via a communication or access link 34. This may include any type of communication connection, such as an Internet or network connection through an interface within the system 10 or otherwise compatible with the system 10. The first and second users 12, 22 are also capable of uploading their respective quantities of content data 14, 24 to the collaboration environment 30 via a content data link 36, which may be any type of communication connection capable of transmitting data. For example, an Internet connection via a web-browser or accessible interface within the system 10 may provide to the first and second user 12, 22 the access link 34 and content data link 36.

The collaboration environment 30 is a network-based platform that is capable of receiving the first and second quantities of content data 14, 24, as well as any other data, from the first and second users 12, 22, or any other users. The collaboration environment 30 may have one or more databases and processors to facilitate the receipt, storage, or transmittal of any data. Other activities that may be conducted using the collaboration environment 30 may include but are not limited to: (1) managing system users and workgroups and associated privileges; (2) creating and managing user profiles; (3) conducting enterprise collaboration tasks (i.e. creating, sharing, and collaborating on documents, spreadsheets, presentations, and charts; (4) conducting discussions; (5) engaging in video conferencing or instant messaging; (6) defining user workflows; and (7) developing widget or plug-ins using a system application programming interface).

The collaboration environment 30 may include a variety of modules, each of which provides a function within the system 10. One of the modules within the collaboration environment 30 is the user collaboration module 40. The user collaboration module 40 may be characterized as a module for facilitating collaboration between the first and second users 12, 22 in relation to the first and second quantities of data 14, 24. The user collaboration module 40 includes a plurality of data tools 42 which are usable by the first and second users 12, 22, and allow the first and second users 12, 22 to collaborate to create a third quantity of content data 16 from the first and second quantities of content data 14, 24. At a basic level, the functions that the user collaboration module 40 provides include at least content management, group collaboration between the first and second users 12, 22 and other users, and workflow management to assist with collaborations of the content data.

The data tools 42 within the user collaboration module 40 are provided to enhance the efficiency, convenience, organization, and usability of the system 10, and allow for the integration and collaboration of the first and second quantities of content data 14, 24. For example, the data tools 42 may include any of the commonly known collaboration and editing tools available in software. This may include tools for identifying changes within documents, managing authorship or edits, messaging and communication systems for discussions, restrictions on editing, contribution identification, security and management, review of edits, bookmarks, and dashboards, just to name a few. Of course, many other data tools 42 may be used as well, all of which are considered within the scope of the present disclosure.

Once created, the third quantity of content data 16 is uploaded to the data processing platform 50 and is integrated with existing content data 52. The existing content data 52 may include any content data that has been previously uploaded to the data processing platform 50. This may include content data from any of the users through any of the additional collaboration environments 32, content data from electronic sources, such as websites or the Internet, or content data from other sources. Integration of the third quantity of content data 16 with the existing content data 52 may compile the content data into a database or plurality of databases stored within the data processing platform 50 and accessible by the users of the system 10. Over time, substantial and significant amounts of data may be compiled into the data processing platform 50, including new data, as well as revisions or edits to existing data.

The data processing platform 50 may be characterized as a platform for accessing and retrieving content data that is compiled by the users of the system 10. Other activities that may be conducted using the data processing platform 50 may include but are not limited to: (1) visualizing data using interactive charts and graphs; (2) searching for data within the data collaboration systems 10 or on the entire world wide web; (3) visualizing, cataloging, discovering, and commenting on data in the form of maps or three-dimensional globes; (4) viewing, categorizing, contributing, integrating, sharing, or commenting on multimedia data; and (5) contributing, sharing, accessing, viewing, and managing data using mobile devices. Integration of the third quantity of content data 16 with the existing content data 52 may be controlled, at least in part, by the additional users 18. For example, once the third quantity of content data 16 is uploaded or transmitted to the data processing platform 50, it may be analyzed and categorized and stored based on the analysis or categorization. This may include storing the third quantity of content data 16 with other data having similar subject matter, by date, location, and/or an associated user. The third quantity of content data 16 may be integrated with the existing content data 52 fully or partially. This may include updating the existing content data 52 with new data supplied by the third quantity of content data 16, and/or filing the third quantity of content data 16 in whole along with the existing content data 52.

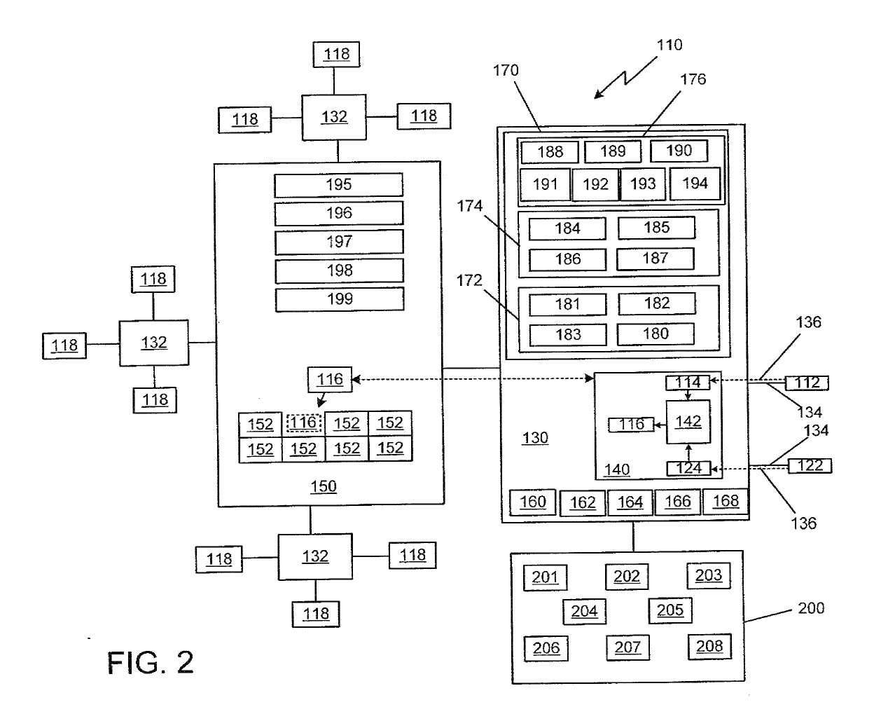

FIG. 2 is a schematic diagram of a data collaboration system 110, in accordance with a second exemplary embodiment of the present disclosure. The data collaboration system 110 (hereinafter, “system 110”) of the second exemplary embodiment may be substantially similar to the data collaboration system 10 of the first exemplary embodiment. Accordingly, any of the structures, features, functions, or characteristics disclosed with respect to the first exemplary embodiment may be included in the second exemplary embodiment.

The data collaboration system 110 includes a first user 112 providing a first quantity of content data 114 and a second user 122 providing a second quantity of content data 124. A collaboration environment 130 is accessible to the first and second users 112, 122, wherein the first and second users 112, 122 provide the first and second quantity of content data 114, 124, respectively, to the collaboration environment 130. A user collaboration module 140 is within the collaboration environment 130 and has a plurality of data tools 142 usable by the first and second users 112, 122. The first and second users 112, 122, in collaboration, use at least a portion of the plurality of data tools 142 to create a third quantity of content data 116 from the first and second quantities of content data 114, 124. The user collaboration module 140 may include a series of online productivity and collaboration tools available to community members including tools, for document management, web-folders for file sharing, calendars, team scheduling, task manager, ‘To-Do’ lists, event management, online meetings, instant messaging, discussion boards, wikis, word processing, spreadsheets, and presentation development.

A data processing platform 150 is in communication with the collaboration environment 130, wherein the third quantity of content data 116 is uploaded to the data processing platform 150 and integrated with existing content data 152. A plurality of additional users 118 have access to the data processing platform 150 through a plurality of additional collaboration environments 132, wherein the plurality of additional users 118 control at least a portion of the integration of the third quantity of content 116 data within the data processing platform 150. Any of the data, including the third quantity of content data 116, that is within the data processing platform 150 may be transmitted back to the collaboration environment 130 or any of the additional collaboration environments 132, and be accessible by any of the users of the system 110.

The system 110 includes additional components, platforms, modules, and functions, which are not described with respect to FIG. 1. These various components, platforms, and modules are discussed herein as independent portions of the system 110 for clarity. However, they can be combined or otherwise configured together in any variation, all of which are considered within the scope of the present disclosure. For example, in addition to the user collaboration module 140, the collaboration environment 130 may include other nonscientific-based modules, including a plug-in development and management module 160, a workflow development and management module 162, a content contribution and management module 164, a user activities module 166, and an administrative processes module 168.

The plug-in development and management module 160, may include tools required to develop widgets or plug-ins utilizing a platform specific Application Programming Interface (API) that may be shared throughout the community to access certain content or conduct common tasks. The workflow development and management module 162 may include tools required to create reusable or re-executable workflows for common tasks as well as a means of organizing them into a workflow library so that other system users may utilize them. The content contribution and management module 164, may include tools required to allow community members to contribute and manage content including content contribution tools for contributing files (word processing, spreadsheets, presentations, etc.) text posts, images, audio files, video, bookmarks, and maps (in various formats), and content management tools for viewing, commenting on, categorizing, geo-tagging, and aggregating various forms of content.

The user activities module 166 may include the necessary tools for a community participant, or user, to create and manage content and profile information in the community. Four specific tools may be considered essential tools. This includes a profile management tool that permits community users to modify information about them in their profile so that other members of the community can obtain personal data associated with a specific user. The tool also allows the profile information to be mapped to the geographic location specified by the user as their current (or home) location. Information relating the user to other users that may be in the same collaboration group can likewise be mapped to show relationships between the various community users. Also included is a contribution setup tool which permits a community user to setup how their content will be presented or shared with other community members. Further, a bookmarks management tool permits community users to add, manage, or delete web hyperlinks to websites or data that might be relevant to a particular project. And lastly, group management tool may allow some community users to be granted the privilege to create and manage working groups of users in the community. These tools allow the user to create groups, grant permissions to join the group, and set permissions for other group members' actions.

The administrative processes module 168 may include the necessary tools for a community administrator to step-up, manage, and maintain online community functions. There may be four tools that are considered essential to this. This includes user and group account management tools which allow community administrators the capabilities to create user accounts and to assign individual users to various groups within the community. Functions may include but are not limited to adding/deleting users, modifying user profiles, managing privileges and access of users and groups. Also, administrator contribution management tools may provide for community administrators, who often have a responsibility to moderate community activities including contributing content themselves or approving or rejecting content contributed by community members. Other administrator tools include categorizing or geotagging contributions. Additionally, RSS feed management tools allowing the community administrators the role of adding, monitoring, managing, and deleting content that is automatically added to the community utilizing RSS or geoRSS Feeds. And lastly, category management tools may be provided, allowing the community administrators the responsibility of adding, deleting, and managing categories into which content in the community is grouped.

The collaboration environment 130 may include a scientific core section 170 having a plurality of modules and sub-modules. The main modules within the scientific core section may include a monitoring and data management module 172, an analysis and modeling module 174, and a decision management module 176. The sub-modules contained within each of these modules may be as follows: the monitoring and data management module 172 may include a data processing and management module 180 capable of extracting, reformatting, and transferring data contained within the system 110, an internal (organizational) data storage and management module 181 capable of maintaining and structuring data stored within the system 110, a field data acquisition module 182 capable of uploading data acquired from remotely accessed sensors, cameras, or monitors located in the field, and an external data/sources access module 183 capable of accessing and retrieving data stored and maintained in federated data repositories or data banks such as those created and managed by federal government science agencies; the analysis and modeling module 174 may include an Earth-systems modeling module 184 capable of numerically simulating natural processes using computer code such as rainfall-run-off processes, watershed processes, ground flow processes, an engineered-systems modeling module 185 capable of maintaining and structure computer-aided architectural or civil engineering designs, a human-systems modeling module 186 capable of quantifying or simulating human-influenced phenomena such as environmental health, infectious diseases, socio-economic systems, and a geospatial analysis module 187 capable of conducting computer-aided analyses of terrain, remotely sensed satellite images, digital elevation models, or geomorphological or topographical maps; and the decision management module 176 may include a qualitative research-Computer-Assisted Qualitative Data Analysis Software module 188 capable of analyzing unstructured qualitative social media or data, a multi-criteria decision analysis module 189, a predictive modeling module 190, a risk analysis module 191, a social network analysis module 192, a semantic search module 193, and a data mining module 194.

The data processing platform 150 may include at least five major, upper-level process modules, each of which may assist with analyzing the content data contained on the data processing platform 150 in some way or another. For example, the data processing platform includes a search module 195, a geospatial mapping module 196, a data visualization module 197, a content access and interaction module 198, and a mobile access and management module 199, as well as other modules. The search module 195 may include basic customizable tools for searching content within the Platform or in the WWW. Searchable items may include documents (eBooks, blog posts, news), images, audio files (podcasts), video, bookmarks, office productivity files (word processing. spreadsheets, presentations, PDF-based reports), and maps (including ESRI'sArcGIS®, Open Geoscience Consortium, and Markup Language compliant formats). The geospatial mapping module 196 may include tools necessary to discover, catalog, and view maps by topic, theme, category, or geographic extent. Map viewing capabilities may allow visualization of both two-dimensional and three-dimensional data from various formats including ESRI'sArcGIS® (shape file, geodatabase, coverage, and Internet Mapping Services),

Open Geoscience Consortium (OGC) compliant formats (Web Mapping Service, Web Feature Service, and Web Coverage Service), Markup Language formats (KML. XML. and geoRSS).

The data visualization module 197 may include a series of tools that are available to visualize many forms of non-geographic data that may best be analyzed in the form of charts, graphs, three-dimensional volumes, and time-variant animations. Numerous tools may be added to this process and would be dependent on the custom design of a specific platform for specific user needs and expectations. The content access and interaction module 198 may include tools available for users to access, interact with, and manage content available in the system 110. This may include viewing documents, images, and videos, commenting on content, aggregating content into groups by project, etc. The system 110 may utilize natural language processing to analyze text in articles, report, or describing photos, videos, or podcasts in an effort to develop semantic metadata from which keywords can be derived that are linked to the multimedia content. These keywords may then be used to categorize the content into any number of users or administrator defined theme and to geo-locate the content onto a map in the location corresponding to the place described by the content. The mobile access and management module 199 may include tablet and smartphone based tools that permit users to access and manage platform content through mobile devices when necessary to travel or to conduct fieldwork.

The scientific core 170, including the modules and components therein, forms an important part of the system 110, and the content of the scientific core 170 depends upon the scientific process, or processes, being evaluated. In many situations, science enterprises have already extensively developed, designed, or adopted modeling systems, databases, and workflows that are familiar to their research staff. In many cases, alternatives for several components can be selected according to the requirements of the scientific questions being raised

An administrative platform 200 may also be included with the system 110. As is shown in FIG. 2, the administrative platform 200 may be in communication with the collaboration environment 130. The administrative platform 200 includes functions and modules that are often incorporated into a network-based system's existing information technology infrastructure. The modules include an infrastructure module 201, a governance module 202, an architecture module 203, a security and authentication module 204, a systems administration module 205, a systems connectivity module 206, a systems configuration module 207, and a disaster recovery module 208.

An important consideration of the administrative platform 200 is that it not only supports the dissemination of completed and verified information to external users; but it also supports the-day-to-day collaborations among individuals and groups as an active project evolves. Such interactions and collaborations may be considered ‘internal’ collaborations. As discussed above, the individuals comprising these internal groups may have very different information needs and user expectations, from individuals in external community groups. This larger external community will have a wide range of information needs and user expectations, and therefore the system 110 must offer styles or user experiences that reflect the information needs and user expectations of the diverse communities of users.

Thus, as can be seen, the data processing platform 150 may provide an entryway for users intending to access and retrieve information or knowledge developed by the science enterprise. These interactions are further supported by the collaboration environment 130, which together, link the technical and scientific analysis operations contained within the various modules of the system 110. With these fundamental components, users will be capable of searching, discovering, posting, mapping, visualizing and archiving data, information, news, and commentary. In addition, these fundamental components will provide essential enterprise security and control functions, including user interaction and access, group management, and content management

In contrast to conventional web-based data management and analysis systems which are developed utilizing an open-source, software-development framework, and are designed predominantly to address the data needs and usage behavior of the scientific community, the system 110 of the present disclosure is constructed to be optimized to employ off-the-shelf and consumer-oriented, hosted web-services, and to accommodate the information needs and web-interface user expectations of the general public. Because the system 110 continues to gather and store the contributions of the scientists, planners, resource managers, community leaders, and general public users utilizing the system, each new assessment benefits from those previously conducted. The geospatial data and models derived from the use of the platform are visualized using industry standard tools, including Google Earth Enterprise® and Google Maps® for Enterprise to enable ease-of-use by both the technical and the general public users. The system 110 may accelerate the deployment of world information including Earth, environmental, engineering, social and economic data and information into an operational knowledge management system that may be quickly used by decision-makers concerned with a host of environmental, energy, economic, engineering, and global security issues throughout the world.

An example of the potential of the system 110 is seen with regards to the Federal need. Many federal agencies have previously achieved success in the development of web-based decision-support and information-dissemination systems, the present invention seeks to extend this portfolio, by a platform designed to be utilized simultaneously by both knowledge providers (government scientists, its contractors, and its collaborators) and knowledge users (societal decision-makers and the general public). However, through the simultaneous use of the system 110 decision-makers have access to the same data and information that experts and scientists use in their research, and can direct science efforts to areas of study that are more relevant to their concerns. This new level of transparency is designed to assist the scientific community in becoming more responsive to the public by creating a new relationship that stresses tangible value and effective communication.

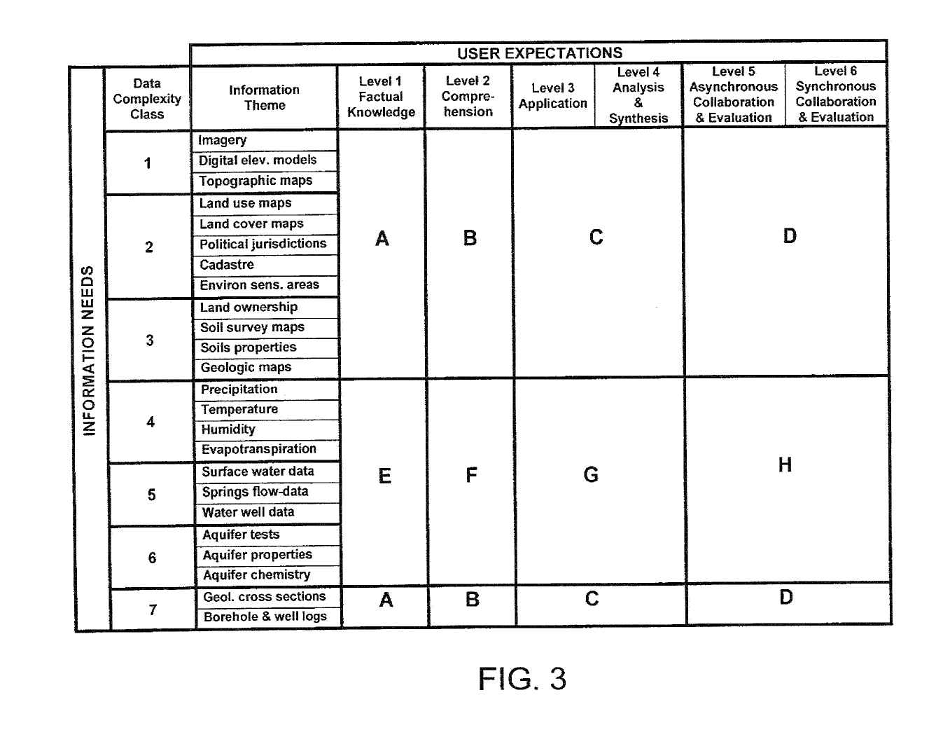

FIG. 3 is a chart illustrating technology groups related to user expectation, information needs, and data complexity of the system 110, in accordance with the second exemplary embodiment of the present disclosure. IN particular, FIG. 3 illustrates eight technology groups that are related to user expectation, information needs, and data complexity. Four of the eight technology groups, groups A-D, are predominantly involved with spatial data displays; they employ maps and models of portions of the Earth's surface representing the area of investigation. They are related to data complexity classes 1-3 and 7. Many of the applications related to data complexity classes 1-3 involve two-dimensional representations—they are maps, plans, or images of the surface of the Earth where topographic elevations can be shown by contour lines, or elevation shading or tints. In other cases, some of these applications use “terrain models” to represent the topography with elevation differences incorporated in the visualization. In most cases, these are not based on a true three-dimensional data structure, but other subsurface models, particularly those related to data complexity class 7, do require a full three-dimensional representation.

Since users employing technology groups A and B require only the most basic capabilities, they typically employ readily available and easy-to-use products such as Google Maps® and NASA World Wind to acquire and view web-based maps, and the simplest GIS products, such as ArcGIS Explorer, IDRISI, or MapInfo, for any desired spatial analysis. These users also typically utilize widely adopted blogging, social networking, and web-based collaboration tools to support their on-line communications and collaborations.

Users employing technology group C utilize more sophisticated technology tools to support their greater information needs and user expectations. Typical applications include Google Earth®, MapServer and GeoServer for acquiring and viewing web-based map information, and more complex GIS tools, such as ArcView and ArcEditor, for their GIS spatial analysis functions. In addition to the typical social networking and web-based collaboration tools, these users may also utilize more advanced community conversation applications, such as Movable Type, Drupal, Joomla, or RSS aggregation tools, to manage and share social information.

Users employing technology group D are mostly members of research scientific and engineering design communities. They have more sophisticated needs and expectations, but also have the ability and experience to use technologies that are more complex. They typically use those applications used by technology group C, but supplement them with more advanced map viewing technologies, such as Google Earth Enterprise®, and the highest-level GIS tools, such as ArcGIS, and specialized three-dimensional visualization and modeling and prediction tools.

The remaining four technology groups, groups E-H, are related to data complexity classes 4-6. These data classes involve more complex data streams, including a variety of temporally varying, as well as spatially-varying multi-attributed data sources. Thus, these technology categories require a more varied suite of technologies to manage and evaluate the information. technology groups E-H utilize various database, data storage, statistical, and graphical display capabilities, often in conjunction with spatial data display technologies used by technology groups A-D, to perform the required tasks.

Users employing technology groups E-H utilize the same applications for mapping and GIS spatial analysis tasks as those users in the corresponding technology groups A-D. However, they also utilize additional database and data analysis tools. Users that employ technology groups E and F require only relatively basic database functions that are readily met by such applications as Microsoft Excel®. A few users may also utilize to at least a limited extent some relational databases such as Access®. In contrast, users that employ technology group G typically use relational databases such as Access® and MySQL to support their information management needs. Users employing technology group H utilize even more robust database and statistical tools supplied by such commercial sources as Microsoft SQLServer® and Oracle Spatial®.

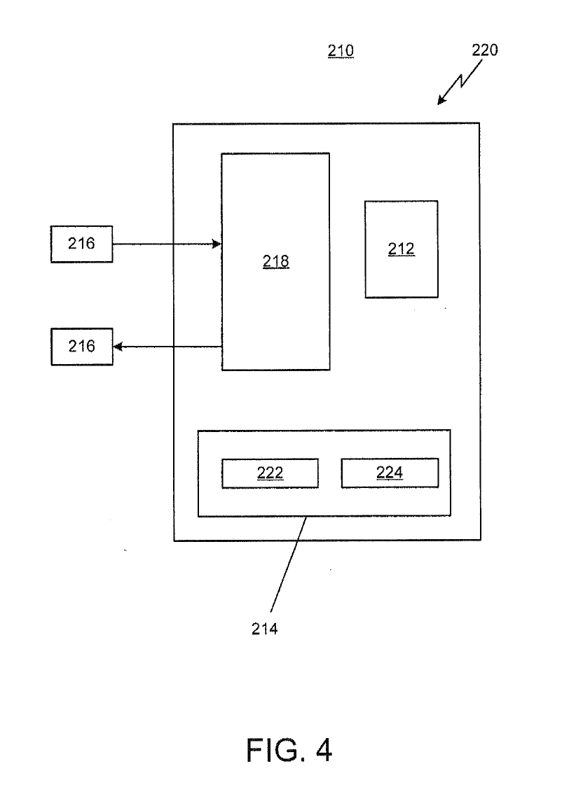

FIG. 4 is a schematic illustration of a general-purpose computer 210, in accordance with a third exemplary embodiment of the present disclosure. The third exemplary embodiment may be used in connection with any of the other embodiments disclosed herein. The general-purpose computer 210, which may be referred to simply as ‘computerized device 210’ or ‘computer 210’ herein, may include any components, in whole or in part, commonly used with a computerized device, but may also include a variety of additional components. Accordingly, the computer 210 of FIG. 4 is to provide clarity in describing the general functioning of a computing system and is not considered limiting to the present disclosure.

The computerized device 210 may include a variety of computer-based components, in whole and in part. For example, the computerized device 210 may be implemented in software (e.g., firmware), hardware, or a combination thereof. Commonly, the computerized device 210 is implemented with both hardware and software, such as a hard drive or memory that stores processor-executable code portions for carrying out instructions, calculations, or other tasks. The software or programmable code may be executed by any special or general purpose digital computer, such as a personal computer (PC; IBM-compatible, Apple-compatible, or otherwise), workstation, minicomputer, smart phone, tablet computer, or mainframe computer.

In terms of hardware architecture, as shown in FIG. 4, the computer 210 includes a processor 212, database 214, and one or more input and/or output (I/O) devices 216 (or peripherals) that are communicatively coupled via a local interface 218 (I/O interface). The local interface 218 can be, for example but not limited to, one or more buses or other wired or wireless connections, as is known in the art. The local interface 218 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 212 is a hardware device for executing software, particularly that stored in the database 214. The processor 212 can be any custom made or commercially available processor, a central processing unit (CPU), an auxiliary processor among several processors associated with the computer 210, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, a 68xxx series microprocessor from Motorola Corporation, a Phenom II X4 975 BE from AMD, or a Pentium E5800 and/or Core 17-990X from Intel Corporation.

The database 214, which may often be referred to as ‘memory,’ can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the database 214 may incorporate electronic, magnetic, optical, and/or other types of storage media. Note that the database 214 can have a distributed architecture, where various components are situated remote from one another, but can be accessed by the processor 212. For example, the database 214 may have a partitioned drive for storage of data in separate and distinct areas with communication therebetween through the processor 212.

The software in the database 214 may include one or more separate programs, each of which comprises an ordered listing of executable instructions for implementing logical functions. The software in the database 214 may include an operating system (O/S) 222, which manages computer hardware resources and provides common services for execution of various software applications 224. A nonexhaustive list of examples of suitable commercially available operating systems 222 includes Windows operating system available from Microsoft Corporation, a Netware operating system available from Novell, Inc., a Macintosh operating system available from Apple Computer, Inc., a UNIX operating system, which is available for purchase from many vendors, such as the Hewlett-Packard Company, Sun Microsystems, Inc., and AT&T Corporation, a LINUX operating system, which is freeware that is readily available on the Internet, a run time Vxworks operating system from WindRiver Systems, Inc., and an appliance-based operating system, such as that implemented in handheld computers or personal data assistants (PDAs) (e.g., PalmOS available from Palm Computing, Inc., and Windows CE available from Microsoft Corporation, Apple iOS available from Apple, Inc., Android OS available from Open Handset Alliance led by Google, Inc.), tablet computers, smart phones and other mobile computing devices.

The operating system 222 may control the execution of other computer programs, namely software applications 224, and provides scheduling, input-output control, file and data management, memory management, and communication control and related services. The software applications 224 may include any type of computer program or software that is installed, downloaded, or otherwise stored, at least in part, in, the database 214. Software applications 224 may include activity or function-specific programs and general functioning programs. For example, a nonexhaustive list of software applications 224 includes programs for word processing (i.e., MS Office Suite available from the Microsoft Corporation), data-processing (i.e. MS Access, MySQL), image processing (i.e., Creative Suite or Adobe Reader available from Adobe Systems, Inc.), gaming, anti-virus, and communication (i.e., AOL Instant Messenger available from America On-Line), or any other software program. Additionally, it is noted that software applications 224 are commonly referred to as ‘Apps.’

The software application 224 on the computer 210 may include a source program, executable program (object code), script, or any other entity comprising a set of instructions to be performed. When a source program, then the program needs to be translated via a compiler, assembler, interpreter, or the like, which may or may not be included within the memory 214, so as to operate properly in connection with the O/S 222. Furthermore, the software application 224 may be written as an object oriented programming language, which has classes of data and methods, or a procedure programming language, which has routines, subroutines, and/or functions, for example but not limited to, C, C++, Pascal, Basic, Fortran, Cobol, Perl, Java, and Ada.

The I/O devices 216 may include input devices, for example but not limited to, a keyboard, mouse, scanner, microphone, communication connection, or other computerized device, etc. Furthermore, the I/O devices 216 may also include output devices, for example but not limited to, a printer, display, etc. The I/O devices 216 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 210 is a PC, workstation, or the like, the software in the database 214 may further include a basic input output system (BIOS) (omitted for simplicity). The BIOS is a set of essential software routines that initialize and test hardware at startup, start the O/S 222, and support the transfer of data among the hardware devices. The BIOS is stored in ROM so that the BIOS can be executed when the computer 210 is activated. When the computer 210 is in operation, the processor 212 is configured to execute software stored within the database 214, to communicate data to and from the database 214, and to generally control operations of the computer 210 pursuant to the software. The O/S 222, in whole or in part, but typically the latter, are read by the processor 212, perhaps buffered within the processor 212, and then executed.

The computer 210 can include software applications 224 which can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The computer 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Alternatively, functioning of the computer 210 may be implemented in hardware, which may require any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is noted that the computer 210 may be a single unitary device having the various components housed therein, or a plurality of interconnected devices connected through a communication connection. Communication connections may include wired connections, wireless connections, connections through other devices (servers), and connections through a network. For example, a plurality of computers 210 may be connected together via a network connection such as the Internet, an extranet, or any other cloud-based network where communication is facilitated. The components of the computer 210, such as the memory 214, may be house and/or stored remote from the processor 212, or other components, and communicate through a network connection. Any configuration of the components of the computer 210 may be possible.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A data collaboration system comprising:
a first user providing a first quantity of content data;
a second user providing a second quantity of content data;
a collaboration environment accessible to the first and second users, wherein the first and second users provide the first and second quantity of content data, respectively, to the collaboration environment;
a user collaboration module within the collaboration environment, the user collaboration module having a plurality of data tools usable by the first and second users, wherein the first and second users, in collaboration, use at least a portion of the plurality of data tools to create a third quantity of content data from the first and second quantities of content data; and
a data processing platform in communication with the collaboration environment, wherein the third quantity of content data is uploaded to the data processing platform and integrated with existing content data, wherein a plurality of additional users have access to the data processing platform through a plurality of additional collaboration environments, wherein the plurality of additional users control at least a portion of the integration of the third quantity of content data within the data processing platform.
